(19) United States
(12) Patent Application Publication
(10) Pub. No.: US 2006/0032332 A1
(43) Pub. Date: Feb. 16, 2006

(54) Cutting tool and cutting machine

(76) Inventor: Kazumasa Ohnishi, Niigata (JP)

Correspondence Address: NIXON PEABODY, LLP, 401 9TH STREET, NW, SUITE 900, WASHINGTON, DC, 20004-2128, US

(21) Appl. No.: 11/253,710

(22) Filed: Oct. 20, 2005

(30) Foreign Application Priority Data
Mar. 13, 2003 (JP) 2003-112148
Mar. 10, 2004 (JP) 2004-067800
May 23, 2005 (JP) 2005-178517

(51) Int. Cl. B23D 63/00

(52) U.S. Cl. 76/25.1

(57) ABSTRACT

A cutting disc blade having a center hole is equipped with a ultrasonic transducer in the form of ring which is coaxially fixed onto one or both surfaces of the disc blade, to give a cutting tool which can be efficiently vibrated with ultrasonic wave.

### FIELD OF THE INVENTION

This invention relates to a cutting tool and a cutting machine favorably employable for cutting rigid material or making a groove on rigid material. The rigid material is such material as glass, silicon, silicon nitride, or hard metal. In particular, the invention relates to a cutting tool having a cutting disc blade which can be vibrated with ultrasonic wave when it is employed for cutting rigid material or making a groove on rigid material.

### BACKGROUND OF THE INVENTION

The cutting machine employing a cutting disc blade is well known.

FIG. 1 illustrates a known cutting machine 10 which comprises a bearing (rotation-driving device) 11, a rotary shaft 12, a pair of flanges 13, 15, a cutting disc blade 14, and a nut or bolt 16 for fixing the disc blade 14 between the flanges 13, 15 around the rotary shaft 12.

Japanese Patent Provisional Publication 2000-210928 (JP-A-2000-210928) describes a cutting machine using a cutting disc blade in which a ultrasonic transducer is attached to one end of the rotary shaft.

According to my study on the cutting machine having a ultrasonic transducer attached to one end of the rotary shaft described in JP-A-2000-210928, this cutting machined has the following disadvantages;

(1) the ultrasonic vibration applied to the cutting disc blade through the rotary shaft is apt to vary depending on the connecting conditions between the rotary shaft and the disc blade, so that the cutting performance is apt to vary in the course of cutting procedures;

(2) when the cutting conditions should be intentionally varied, not only the ultrasonic transducer should be replaced but also the rotary shaft should be replaced, and adjustment of the relationship between the new ultrasonic transducer and the new rotary shaft, and adjustment of the connecting condition between the disc blade and the rotary shaft should be made.

### SUMMARY OF THE INVENTION

It is an object of the invention to provide a cutting machine which can maintain its cutting performance stably in the course cutting procedure and which can easily comply with requirements of optional variation of cutting conditions.

It is another object of the invention to provide a cutting machine efficiently utilizing vibration supplied by a ultrasonic transducer.

It is a further object of the invention to provide a cutting tool which is employable even in the conventional cutting machines having a rotary shaft equipped with no ultrasonic transducer.

The present invention resides in a cutting tool comprising a cutting disc blade having a center hole and a ultrasonic transducer in the form of ring which is coaxially fixed at least on one surface of the disc blade.

The invention further resides in a cutting machine comprising a bearing, a rotary shaft rotatably mounted to the bearing, a cutting tool which comprises a cutting disc blade having a center hole and a ultrasonic transducer in the form of ring which is coaxially fixed at least on one surface of the disc blade and which is mounted around the rotary shaft, and a power source electrically connected to the ultrasonic transducer.

The invention further resides in a cutting machine comprising a bearing, a rotary shaft having a pair of radially extended flanges which is rotatable mounted to the bearing, a cutting tool which comprises a cutting disc blade having a center hole and a ultrasonic transducer in the form of ring which is coaxially fixed on each surface of the disc blade via rigid material layer in the form of ring under such condition that an outer periphery of the rigid material layer extends over an outer periphery of the ultrasonic transducer and which is mounted around the rotary shaft under such condition that the cutting tool is supported by the pair of radially extended flanges at an outer peripheral area of the rigid material layer, and a power source electrically connected to the ultrasonic transducer.

The invention furthermore resides in a cutting machine conprising a bearing, a rotary shaft having a pair of radially extended flanges which is rotatably mounted to the bearing, a cutting tool which comprises a cutting disc blade having a center hole and a ultrasonic transducer in the form of ring which is coaxially fixed on each surface of the disc blade and which is mounted around the rotary shaft under such condition that the cutting tool is supported by the pair of radially extended flanges via resin material at an outer peripheral area of the ultrasonic transducer, and a power source electrically connected to the ultrasonic transducer.

### BRIEF DESCRIPTION OF THE DRAWING

FIG. 1 illustrates a conventional cutting machine using a cutting disc blade.

FIG. 2 illustrates a cutting tool of the invention comprising a cutting disc blade and a ultrasonic transducer fixed onto a surface of the disc blade.

FIG. 3 illustrates a section of the cutting tool of FIG. 2 taken along the line I-I which further shows an electric power-supplying system for activating the ultrasonic transducers.

FIG. 4 illustrates a cutting machine of the invention employing a cutting tool of the invention in which ultrasonic transducers are activated by electric current which is supplied by means of a slip ring.

FIG. 5 illustrates a cutting machine of the invention employing a cutting tool of the invention in which ultrasonic transducers are activated by electric current which is supplied by means of a rotary transformer.

FIG. 6 illustrates a cutting tool of the invention in which the ultrasonic transducer is divided into plural pieces.

FIG. 7 illustrates a cutting tool of the invention in which the ultrasonic transducer is divided into plural areas in which adjoining ultrasonic transducer areas are polarized in opposite directions.

FIG. 8 illustrates a cutting tool of the invention in which the ultrasonic transducers are covered and protected by insulating material.

FIG. 9 illustrates a cutting tool of the invention in which the ultrasonic transducers are fixed to the cutting disc blade via a rigid material layer.

FIG. 10 illustrates a cutting machine of the invention in which a cutting tool is supported by a pair of flanges radially extended from the rotary shaft in the vicinity of the outer periphery via a rigid material layer placed between the disc blade and the transducer, and the ultrasonic transducers are activated by electric current supplied by a rotary transformer attached to a bearing and a rotary shaft.

FIG. 11 illustrates a cutting machine of the invention in which a cutting tool is supported by a pair of flanges radially extended from the rotary shaft in the vicinity of the outer periphery via a rigid material layer placed on the disc blade in contact with the outer periphery of the ultrasonic transducer, and the ultrasonic transducers are activated by electric current supplied by a rotary transformer attached to a bearing and a rotary shaft.

FIG. 12 illustrates a cutting machine of the invention in which a cutting tool is supported by a pair of flanges radially extended from the rotary shaft in a vicinity of the outer periphery via a resin material placed on the ultrasonic transducer, and the ultrasonic transducers are activated by electric current supplied by a rotary transformer attached to a bearing and a rotary shaft.

FIG. 13 illustrates a cutting machine of the invention in which a cutting tool is supported by a pair of flanges radially extended from the rotary shaft in the vicinity of the outer periphery via a rigid material layer placed between the disc blade and the transducer (the disc blade, rigid material layers and transducers are combined by means of binding means provided around the inner periphery of the disc blade), and the ultrasonic transducers are activated by electric current supplied by a rotary transformer attached to a bearing and a rotary shaft.

FIG. 14 illustrates a cutting machine equipped with a plurality of cutting tools of the invention which are arranged in parallel around the rotary shaft and supported by flanges extended radially from the rotary shaft.

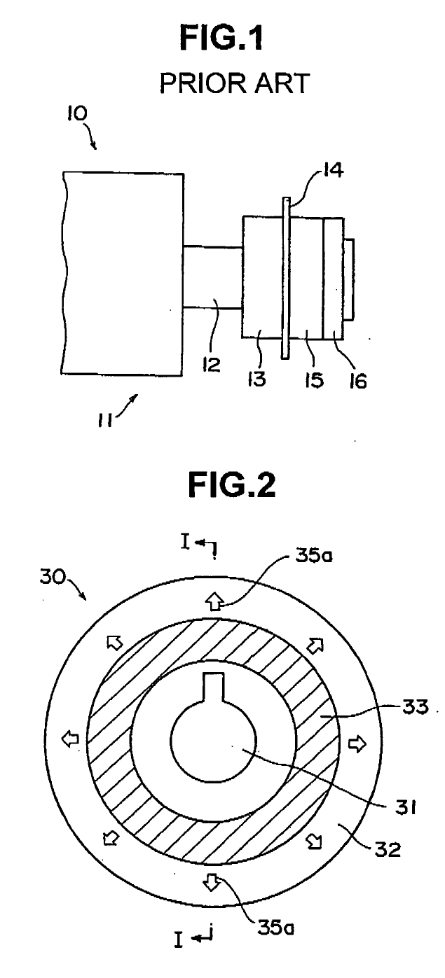

### DETAILED DESCRIPTION OF THE INVENTION

The preferred embodiments of the cutting tool of the inventions are described below.

(1) The ultrasonic transducer is fixed onto each surface of the disc blade.

(2) The ultrasonic transducer is covered with insulating material.

(3) The ultrasonic transducer is divided into two or more pieces.

(4) The ultrasonic transducer is fixed to the disc blade via a rigid material layer in the form of ring.

(5) An outer periphery of the rigid material layer extends over an outer periphery of the ultrasonic transducer.

(6) The rigid material layer comprises metal or ceramics.

(7) The rigid material layer in the form of ring is fixed to the surface of the disc blade under the condition that an inner periphery edge thereof is kept in contact with the ultrasonic transducer.

(8) A resin material layer is placed on the ultrasonic transducer.

(9) A resin material layer in the form of ring is placed on the ultrasonic transducer.

The present invention is further described by referring to the figures given in the attached drawings.

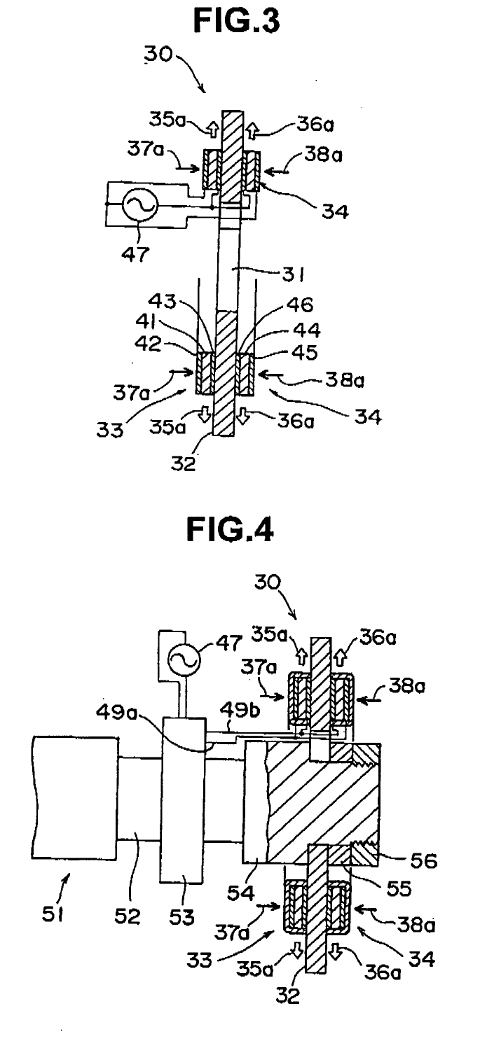

The cutting tool of the invention comprises a cutting disc blade having a center hole and a ultrasonic transducer in the form of ring which is coaxially fixed at least on one surface of the disc blade, as illustrated in FIGS. 2 and 3.

In FIGS. 2 and 3, the cutting tool 30 comprises a cutting disc blade 32 having a center hole 31 and a ultrasonic transducers 33, 34 in the form of ring which are coaxially fixed on each surface of the disc blade 32. The ultrasonic transducer 33, 34 comprises a piezoelectric element 41, 44 in the form of ring which has an electrode 42, 43, 45, 46 in the form of ring on each side. The piezo-electric element 41, 44 is polarized in the thickness direction (indicated by arrows 37a, 38a). When the ultrasonic transducers 33, 34 are activated by applying alternating electric current (supplied by a power source 47) between the electrodes 42 and 43, and between electrodes 45 and 46, the transducers vibrate on the disc blade 32, for example, first outwardly (in the directions indicated allows 35a) and then inwardly. The disc blade 32 to which the ultrasonic transducers 33, 34 are fixed is then vibrates in the same manner.

The cutting disc blade can be one of the known cutting disc blade, such as a disc plate having its surfaces abrasive particles or a disc saw. The piezoelectric element also can be made of known materials such as PZT, crystal, LiNbO₃, or LiTaO₃.

FIG. 4 illustrates a cutting machine according to the invention which employs a cutting tool of the invention in which ultrasonic transducers are activated by electric current which is supplied by means of a slip ring.

The cutting machine employing the cutting tool of the invention can be constructed in various way.

FIG. 4 illustrates a cutting machine according to the invention comprising a bearing 51, a rotary shaft 52 having two flanges 54, 55 which is rotatably mounted to the bearing 51, a cutting tool 30, and a power source 47 electrically connected to the ultrasonic transducers 33, 34 through a slip ring 53 and wires 49a, 49b. The flanges 54, 55 connected to the front portion of the rotary shaft 52 are bolted together using a nut 56 so as to fixedly support the cutting tool 30 on the rotary shaft 52.

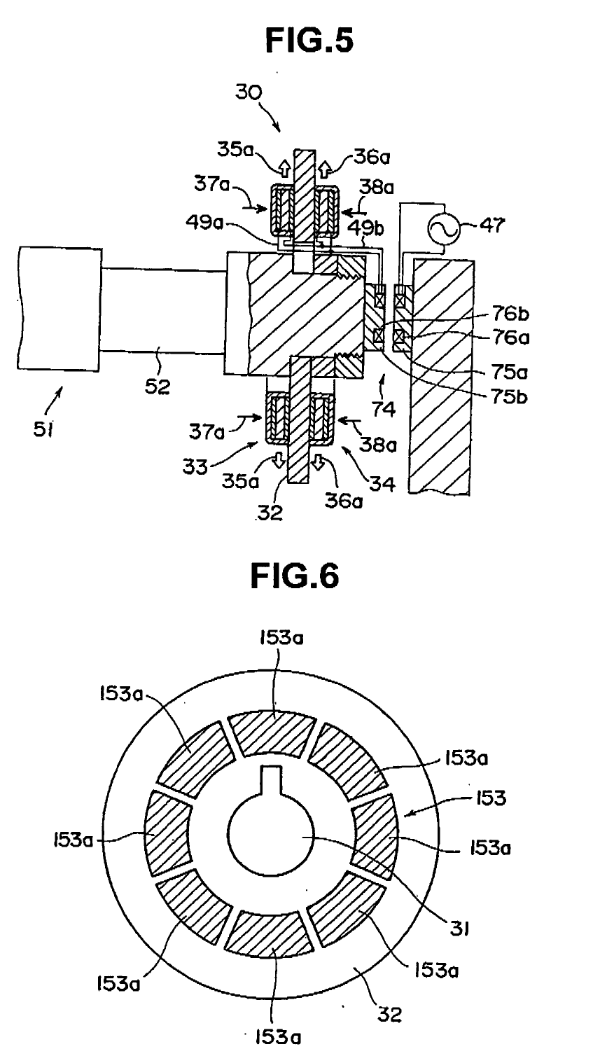

As is seen from FIG. 5, the electric power supplied by the power source 47 can be transmitted to the ultrasonic transducers 33, 34 through a rotary transformer 74 and wires 49a, 49b. The rotary transformer 74 has a stator core 75a and a stator coil 76a as well as a rotor core 75b and a rotor coil 76b.

The ultrasonic transducer of the cutting tool of the invention can be divided into plural pieces as illustrated in FIG. 6. In FIG. 6, the ultrasonic transducer 153 is divided into eight ultrasonic transducer pieces 153a.

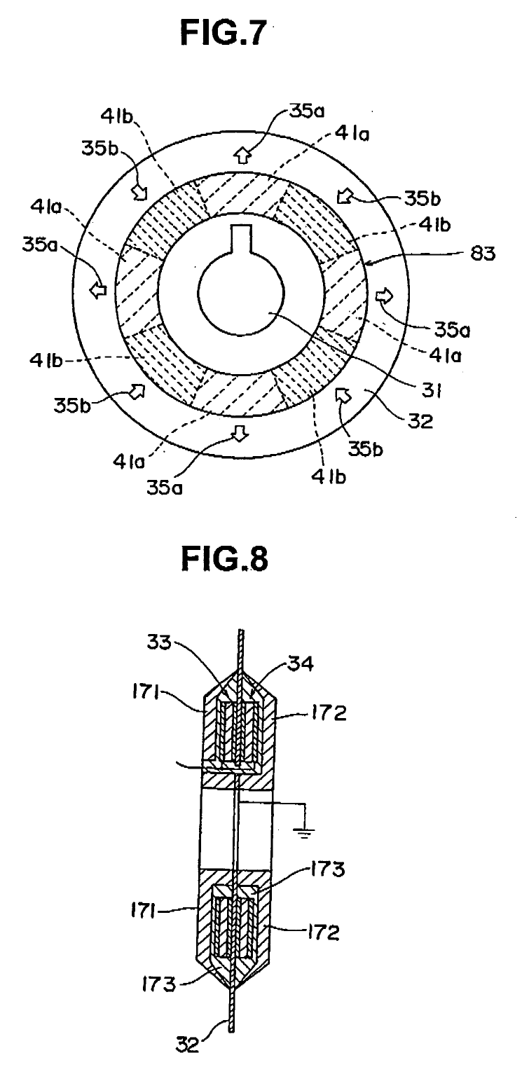

The ultrasonic transducer of the cutting tool of the invention can be divided into plural areas with respect to the direction of polarization. In FIG. 7, the ultrasonic transducer 83 is divided into eight areas. The adjoining areas 41a, 41b are polarized along the thickness of the transducer but in opposite directions. Accordingly, the adjoining areas 41a, 41b vibrate alternately in opposite directions (such as the direction indicated by arrows 35a, 35b) on the surface of the disc blade 32 when alternating current is applied to the ultrasonic transducer 83. Accordingly, the disc blade 32 vibrates on its plane in the same manner.

The ultrasonic transducer on the disc blade can be covered with insulating material. In FIG. 8, the ultrasonic transducers 33, 34 are covered with insulating material 173 such as resinous material. The insulating material 173 can be encased in a protective cover 171, 172. The insulating material can keep the transducer from atmospheric humid condition or inadvertent contact with water or foreign material.

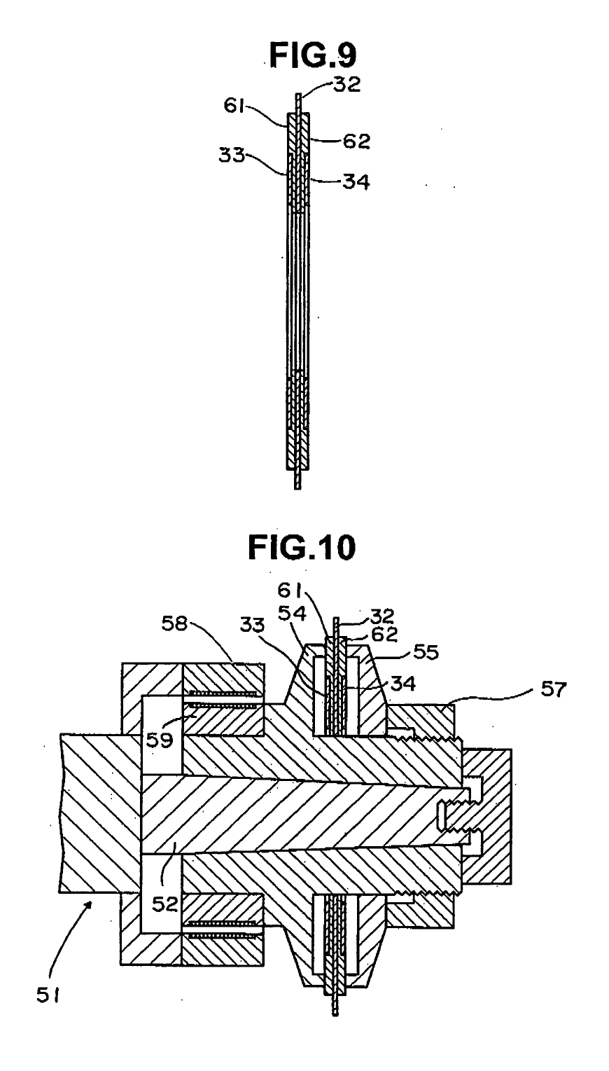

The ultrasonic transducer can be fixed to the disc blade via a rigid material layer in the form of ring. In FIG. 9, the ultrasonic transducers 33, 34 are fixed to the disc blade 32 via rigid material layers 61, 62, respectively. The transducers 33, 34 can be embedded on the rigid material layer 61, 62 in the inner peripheral area as is illustrated in FIG. 9. The rigid material layer can reinforce the disc blade when the disc blade is such thin as having a thickness of less than 1 mm, particularly less than 0.1 mm. The rigid material layer also can serve as a medium for transmitting ultrasonic wave from the ultrasonic transducer to the outer peripheral edge of the disc blade. Further, the rigid material layer can serve as a cushion medium with which an edge of a flange extended from the rotary shaft is brought into contact for supporting the cutting tool. Accordingly, the rigid material layer is preferably made of a metal or ceramics, such as aluminium alloy, titanium, alumina, or glass. The rigid material layer can be fixed onto the surface of the disc blade via insulating material such as grease.

FIG. 10 illustrates a section of a cutting machine utilizing the cutting tool of FIG. 9. The cutting machine of FIG. 9 comprises a bearing 51, a rotary shaft 52 having a pair of radially extended flanges 54, 55 which is rotatably mounted to the bearing 51, a cutting tool which comprises a cutting disc blade 32 having a center hole and a ultrasonic transducer 33, 34 in the form of ring which is coaxially fixed on each surface of the disc blade 32 via rigid material layer 61, 62 in the form of ring under such condition that an outer periphery of the rigid material layer 61, 62 extends over an outer periphery of the ultrasonic transducer 33, 34 and which is mounted around the rotary shaft 52 under such condition that the cutting tool is supported by the pair of radially extended flanges 54, 55 at an outer peripheral area of the rigid material layer 61, 62, and a power source (not shown) electrically connected to the ultrasonic transducer 33, 34. In FIG. 10, the ultrasonic transducer 33, 34 is connected electrically to the power source by means of a rotary transformer comprising a power supplying unit 58 (fixed to the bearing 51) and a power receiving unit 59 (fixed to the rotary shaft 52). The cutting tool is supported at its outer peripheral area by a pair of flanges 54, 55 which are brought into contact with each other via the disc blade by means of a nut 57.

The insulating material layer can be fixed onto the surface of the disc blade under the condition that an inner periphery edge thereof is kept in contact with the ultrasonic transducer.

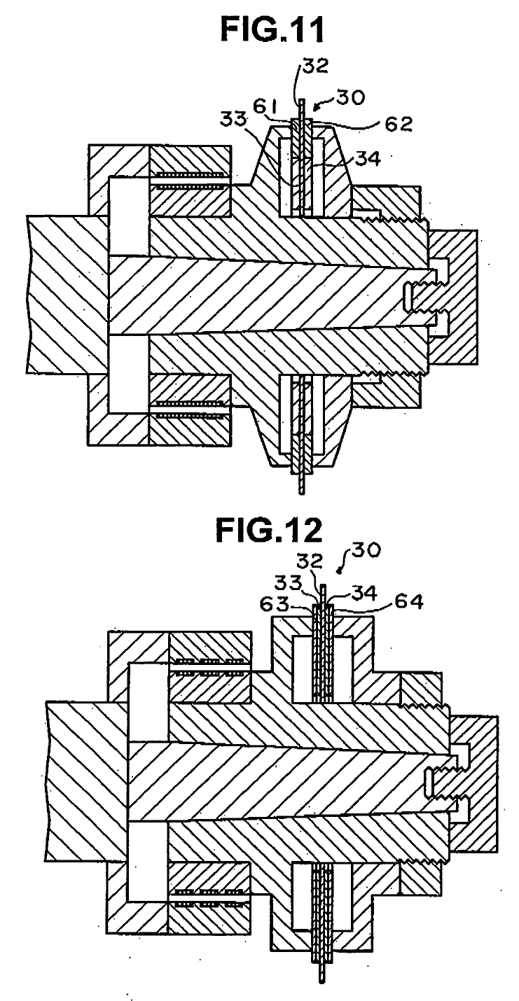

In FIG. 11, a cutting machine of the same structure as that of FIG. 10 except for the structure of cutting tool 30 is illustrated. The cutting tool of FIG. 11 has a disc blade 32, a pair of ultrasonic transducers 33, 34, and a pair of rigid material layers 61, 62. The rigid material layers 61, 62 are fixed to the surface of the disc blade 32 under the condition that an inner periphery edge thereof is kept in contact with the ultrasonic transducer 33, 34.

The ultrasonic transducer fixed on the disc blade can have an insulating resin material coat on its free surface. The insulating resin material coat can comprise carbon fiber reinforced plastics (CFRP) or other resinous material. The insulating resin material coat can serve as a cushion medium intervening the transducer and the top of the flange (supporting tool) extended from the rotary shaft. The cushion medium can keep the ultrasonic transducer from physical damage that may be caused by the contact with the flange. Otherwise, the cushion medium can be provided to the top of the flange. The-cushion medium can further serve for keeping ultrasonic wave generated by the ultrasonic transducer from excaping into the flange.

In FIG. 12, a cutting machine of the same structure as that of FIG. 10 except for the structure of cutting tool 30 is illustrated. The cutting tool of FIG. 12 has a disc blade 32, a pair of ultrasonic transducers 33, 34, and a pair of insulating resin material coats 63, 64 placed on the transducers.

FIG. 13 illustrates a cutting machine of the same structure as that of FIG. 10 except that a pair of rigid material layers 61, 62, a pair of ultrasonic transducers 33, 34 and insulating resin material coats 63, 64 are combined by means a binding means 66 attached to the inner periphery of the disc blade 32. The binding means are preferably made of insulating material.

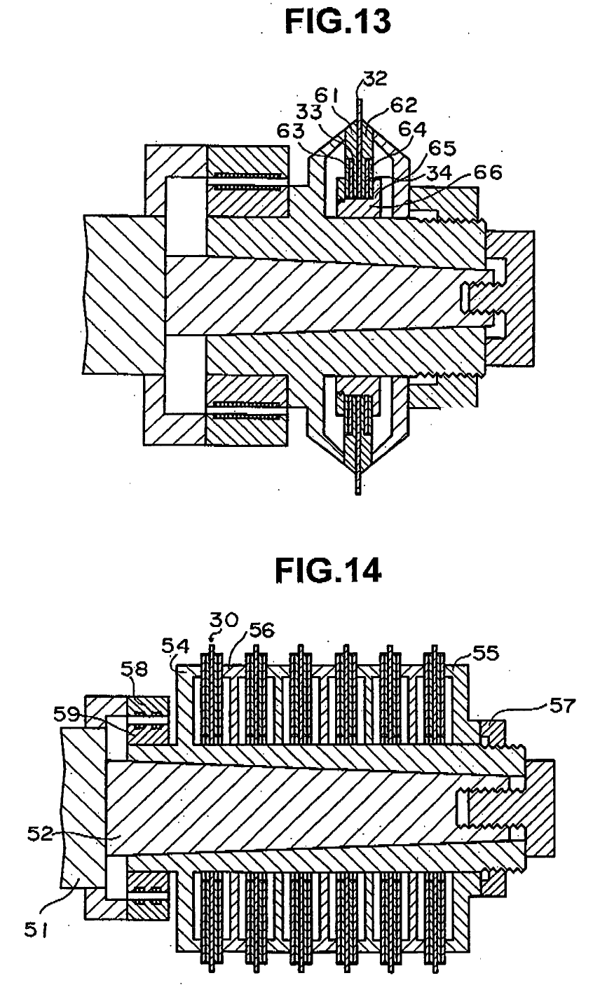

FIG. 14 illustrates a cutting machine equipped with a plurality of cutting tools 30 of the invention which are arranged in parallel around the rotary shaft 52 and supported by flanges 54, 55, 56 extended radially from the rotary shaft 52.

In FIG. 14, the ultrasonic transducer of the cutting tool 30 is connected electrically to the power source by means of a rotary transformer comprising a power supplying unit 58 (fixed to the bearing 51) and a power receiving unit 59 (fixed to the rotary shaft 52). The cutting tool 30 is supported at its outer peripheral area by flanges 54, 55, 56 which are brought into contact with each other via cutting tool 30 by means of a nut 57.

What is claimed is:

1. A cutting tool comprising a cutting disc blade having a center hole and a ultrasonic transducer in the form of ring which is coaxially fixed at least onto one surface of the disc blade.

2. The cutting tool of claim 1, wherein the ultrasonic transducer is fixed onto each surface of the disc blade.

3. The cutting tool of claim 1, wherein the ultrasonic transducer is covered with insulating material.

4. The cutting tool of claim 1, wherein the ultrasonic transducer is divided into two or more pieces.

5. The cutting tool of claim 1, wherein the ultrasonic transducer is fixed to the disc blade via a rigid material layer in the form of ring.

6. The cutting tool of claim 5, wherein an outer periphery of the rigid material layer extends over an outer periphery of the ultrasonic transducer.

7. The cutting tool of claim 5, wherein the rigid material layer comprises metal or ceramics.

8. The cutting tool of claim 1, wherein a rigid material layer in the form of ring is fixed to the surface of the disc blade under the condition that an inner periphery edge thereof is kept in contact with the ultrasonic transducer.

9. The cutting tool of claim 1, wherein a resin material layer is placed on the ultrasonic transducer.

10. The cutting tool of claim 6, wherein a resin material layer in the form of ring is placed on the ultrasonic transducer.

11. A cutting machine comprising a bearing, a rotary shaft rotatably mounted to the bearing, a cutting tool which comprises a cutting disc blade having a center hole and a ultrasonic transducer in the form of ring which is coaxially fixed at least onto one surface of the disc blade and which is mounted around the rotary shaft, and a power source electrically connected to the ultrasonic transducer.

12. The cutting machine of claim 11, wherein the power source is electrically connected to the ultrasonic transducer via a rotary transformer which comprises a power supplying unit fixed to the bearing and a power receiving unit fixed to the rotary shaft.

13. A cutting machine comprising a bearing, a rotary shaft having a pair of radially extended flanges which is rotatably mounted to the bearing, a cutting tool which comprises a cutting disc blade having a center hole and a ultrasonic transducer in the form of ring which is coaxially fixed onto each surface of the disc blade via rigid material layer in the form of ring under such condition that an outer periphery of the rigid material layer extends over an outer periphery of the ultrasonic transducer and which is mounted around the rotary shaft under such condition that the cutting tool is supported by the pair of radially extended flanges at an outer peripheral area of the rigid material layer, and a power source electrically connected to the ultrasonic transducer.

14. A cutting machine comprising a bearing, a rotary shaft having a pair of radially extended flanges which is rotatably mounted to the bearing, a cutting tool which comprises a cutting disc blade having a center hole and a ultrasonic transducer in the form of ring which is coaxially fixed onto each surface of the disc blade and which is mounted around the rotary shaft under such condition that the cutting tool is supported by the pair of radially extended flanges via resin material at an outer peripheral area of the ultrasonic transducer, and a power source electrically connected to the ultrasonic transducer.
